(19) United States
(12) Patent Application Publication
(10) Pub. No.: US 2025/0297488 A1
(43) Pub. Date: Sep. 25, 2025

(54) POOL CLEANER SYSTEMS AND METHODS

(71) Applicant: Pentair Water Pool and Spa, Inc., Cary, NC (US)

(72) Inventors: Azur Dzindo, Raleigh, NC (US); Anas Alhajeh, Clayton, NC (US)

(21) Appl. No.: 19/088,519

(22) Filed: Mar. 24, 2025

Related U.S. Application Data
(60) Provisional application No. 63/568,775, filed on Mar. 22, 2024.

(51) Int. Cl. E04H 4/16; G05D 1/648; G05D 1/661; G06V 10/764

(52) U.S. Cl. CPC E04H 4/1654; G05D 1/648; G05D 1/661; G06V 10/764

(57) ABSTRACT

An aquatic cleaning system includes a pool cleaner having a housing, a drive system for moving the housing, and a debris basket associated with the housing. The debris basket is designed to receive debris from the aquatic environment. The system includes a data capture system including an imaging device operably coupled to the cleaner. The system also includes a detection system having a storage medium storing a trained model, and a processor designed to receive data elements from the data capture system and input the data elements into the trained model to identify a detected object within the aquatic environment as being debris or non-debris. The system also includes a control system in communication with the detection system and the drive system to move the pool cleaner toward the detected object identified by the detection system when the detected object is identified by the detection system as being debris.

### CROSS-REFERENCES TO RELATED APPLICATIONS

This application claims the benefit of, and priority to, U.S. provisional patent application No. 63/568,775, filed Mar. 22, 2024, which is incorporated herein in its entirety by reference.

### FIELD OF THE INVENTION

The field of the present disclosure relates generally to systems and methods for automatic pool cleaners for aquatic environments, and, more particularly, for detecting and classifying debris and non-debris in aquatic environments.

### BACKGROUND

A number of different automatic pool cleaners exist. Most automatic pool cleaners include components for driving the pool cleaner along the floor and sidewalls of a pool or a spa, either in a random or deliberate manner, to vacuum debris on and adjacent to the floor and sidewalls of the pool or spa. Such automatic pool cleaners are powered using various mechanical and electrical power sources. For example, in conventional pool cleaners, a turbine assembly drives one or more wheels using pressure-side or suction-side tubing. In the case of robotic pool cleaners, an electrical power source (e.g., a battery) provides energy to a motor or other mechanical system to drive one or more wheels. An example of a structure of a pool cleaner is described in U.S. Pat. No. 11,339,580 B2, filed on Aug. 22, 2018, and issued on May 24, 2022, and assigned to Pentair Water Pool and Spa, Inc., which is hereby incorporated herein in its entirety.

Most existing pool cleaners operate according to random algorithms. In other words, the path the pool cleaner travels to collect debris is random. As a result, existing pool cleaners traverse the entirety of the pool or spa before the pool or spa is sufficiently free of debris. Currently available power sources do not provide sufficient power for the pool cleaner to traverse the entire pool or spa. As a result, the pool cleaner only removes a portion of the debris in the pool before the power source must be recharged or replaced.

To address these shortcomings, some pool cleaners are operated in a more deliberate manner, e.g., utilizing a control algorithm. Such control algorithms may use an underwater imaging device such as a camera to detect debris in the pool or spa, and the pool cleaner is controlled to drive toward the detected debris. However, such algorithms may fail to identify debris or may falsely identify non-debris as debris. For example, the pool cleaner may incorrectly identify manufactured objects, such as toys or jewelry, or parts of the pool or spa, such as a drain or in-floor cleaning pop-up head, as debris, or the pool cleaner may fail to identify actual debris, such as leaves or sticks, in the pool. Accordingly, control algorithms do not function to clean a swimming pool much better than the random algorithms.

### SUMMARY

The present disclosure is directed generally to systems and methods for automatic cleaners for aquatic environments. In one instance, systems and methods for automatic cleaners for aquatic environments may detect and classify debris and non-debris in aquatic environments. In another instance, systems and methods for automatic cleaners for aquatic environments may map the size and shape of an aquatic environment.

In one aspect of the present disclosure, an aquatic cleaning system may be provided to locate and remove debris from an aquatic environment. The aquatic cleaning system includes a pool cleaner having a housing, a drive system designed to move the housing, and a debris basket associated with the housing. The system also includes a data capture system having at least one imaging device. The data capture system is operably coupled to the pool cleaner. The system also includes a detection system having a storage medium including a trained model, a processor designed to receive data elements from the data capture system and input the data elements into the trained model to identify a detected object within the aquatic environment as being debris or non-debris. A control system is in communication with the detection system and the drive system, the control system is designed to operate the drive system to move the cleaner toward the detected object identified by the detection system when the detected object is identified by the detection system as being debris.

In some instances, the detection system may be further designed to perform at least one of: avoiding the identified non-debris, not collecting the identified non-debris, ignoring the identified non-debris, sending a notification related to the identified non-debris, or collecting the identified non-debris. In some instances, the non-debris may include at least one of a drain, a toy, jewelry, an owner possession, or a manufactured object.

In some instances, the data capture system includes an image processing system designed to receive images from the at least one imaging device and to process the images to filter and/or clarify at least one object in the image. In some instances, the plurality of data elements include a high-resolution image. In some instances, the training model includes an image library having images. The detection system determines a type of detected object by comparing the received images to images in the image library. In some instances, the images in the image library include images related to a leaf, a stick, jewelry, a toy, a ring, a necklace, a bracelet, a fixed object, a drain, and an in-floor cleaning pop-up head. In some instances, machine learning uses the training model to classify a detected object and generate one or more confidence scores. In some instances, a cleaning pathway is assigned based on the one or more confidence scores.

In some instances, the imaging device is a camera. In some instances, the data capture system further includes one or more ultrasonic sensors. In some instances, the control system is further designed to use inputs from the one or more ultrasonic sensors to determine a distance to the detected object and to determine a size of the detected object based on the determined distance. In some instances, the drive system includes an encoder designed to measure a distance traveled by the cleaner. In some instances, the measured distance is used to map a shape and size of the aquatic environment.

In another aspect, a method for operating an aquatic cleaning system to locate and remove debris from an aquatic environment is provided. The method includes providing a pool cleaner having a data capture system including at least one imaging device and a detection system, capturing an image of the aquatic environment via the at least one imaging device, providing the image to the detection system, performing image processing on the image, and identifying debris and non-debris in the image based on an output generated by the detection system.

In one instance, the method includes outputting a notification if the non-debris is detected. In another instance, the method includes controlling the pool cleaner to collect the debris identified by the detection system, ignore the non-debris identified by the detection system, or return the pool cleaner to a docking station for recharging.

In another instance, the method includes providing a strobe, a flash, or other artificial light to illuminate the debris or the non-debris as the image is being captured. In a further instance, the method includes determining if the image is too blurry, performing a sharpening operation if the image is too blurry, and removing one or more caustics if the image is not blurry.

In a further aspect, an aquatic cleaning system to locate and remove debris from an aquatic environment is disclosed. The aquatic cleaning system includes a pool cleaner having a drive system designed to move the pool cleaner and a data capture system in communication with the pool cleaner. The aquatic cleaning system also includes a detection system designed to receive a plurality of data elements from the data capture system and input the plurality of data elements into a trained model to identify a detected object within the aquatic environment as being debris or non-debris and output an image having confidence score associated with the image. The aquatic cleaning system further includes a controller in communication with the detection system and the drive system, the controller engaging the drive system to move the pool cleaner toward the detected object identified by the detection system when the detected object is identified by the detection system as being debris.

### BRIEF DESCRIPTION OF THE DRAWINGS

The accompanying drawings, which are incorporated in and form a part of this specification, illustrate examples of the invention and, together with the description, serve to explain the principles of the invention.

FIG. 1 is an isometric view of an example cleaning system for an aquatic environment;

FIGS. 2A and 2B are front and side isometric views of an example cleaning system for an aquatic environment;

FIG. 3 is a schematic view of an aquatic environment including the cleaning systems of FIG. 1 or FIGS. 2A and 2B;

FIG. 4 is a flow chart illustrating a method for operating the cleaning systems of FIG. 1 or FIGS. 2A and 2B;

FIG. 5 is a flow chart illustrating an image processing method for the cleaning systems of FIG. 1 or FIGS. 2A and 2B;

FIG. 6 is a flow chart illustrating a method for generating a trained model for operating the cleaning systems of FIG. 1 or FIGS. 2A and 2B;

FIG. 7 is an image illustrating data for generating a trained model for operating the cleaning systems of FIG. 1 or FIGS. 2A and 2B;

FIG. 8 is a flow chart illustrating a method for operating the cleaning systems of FIG. 1 or FIGS. 2A and 2B;

FIG. 9 is a process diagram illustrating an image processing method for the cleaning systems of FIG. 1 or FIGS. 2A and 2B;

FIG. 10 is an example image illustrating an image processing operation for an aquatic environment; and

FIG. 11 is a schematic of an example control module or system for a pool cleaner.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, example embodiments of the invention are not intended to be limited to the examples shown but are to be accorded the widest scope consistent with the principles and features disclosed herein. The following detailed description is to be read with reference to the figures, in which like elements in different figures have like reference numerals. The figures, which are not necessarily to scale, depict selected example embodiments and are not intended to limit the scope of embodiments of the invention. Skilled artisans will recognize the examples provided herein have many useful alternatives and fall within the scope of embodiments of the invention.

Before any example embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As explained above, it would be useful to provide a pool cleaner for an aquatic environment, such as a pool or spa, capable of identifying and/or classifying objects as being debris or non-debris. It would also be useful to provide a cleaner for an aquatic environment capable of mapping the shape and size of the environment to improve a path of operation to conserve energy and/or reduce battery usage.

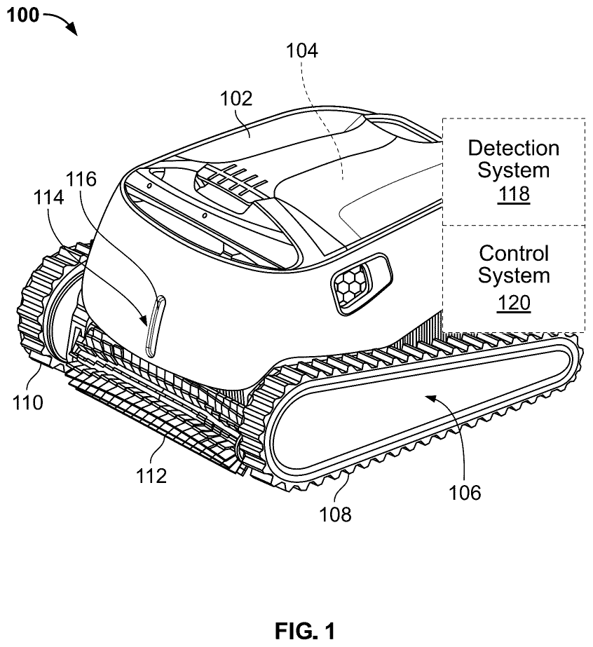

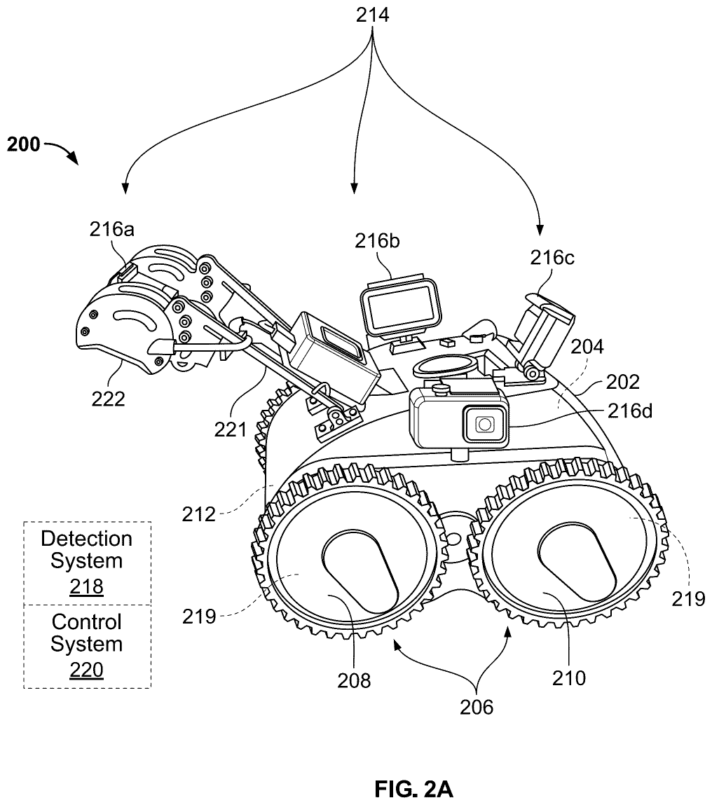

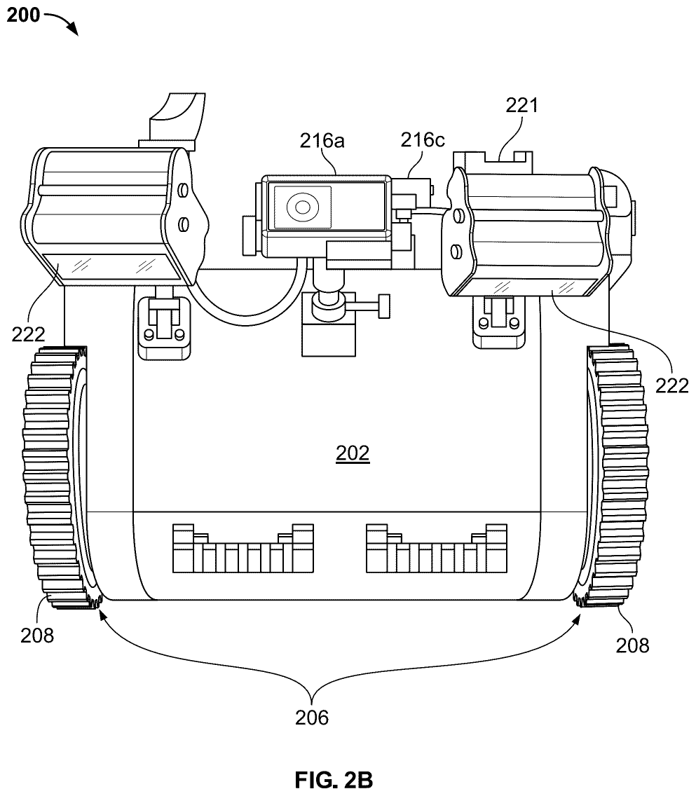

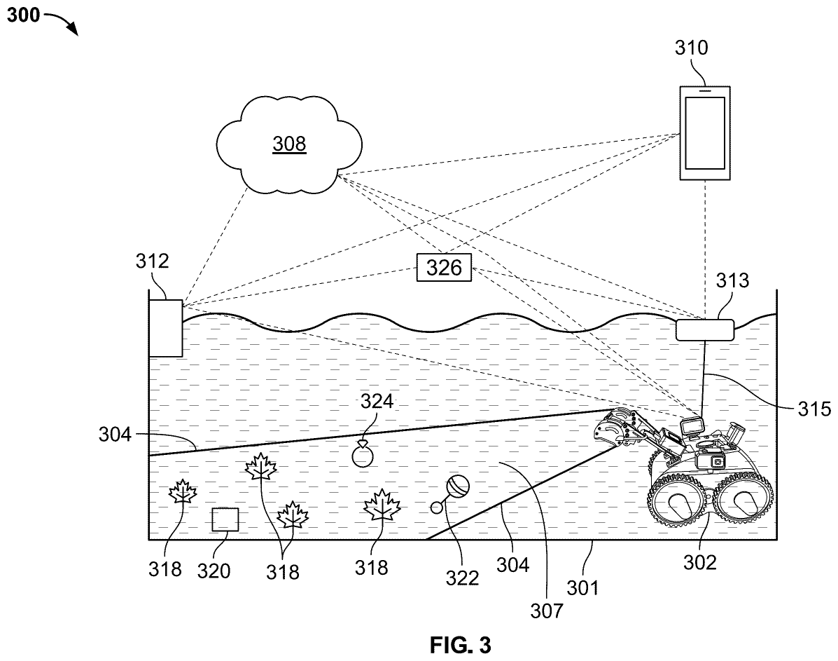

FIGS. 1, 2A, and 2B depict an example aquatic cleaner or cleaning system, e.g., a pool cleaner 100 of FIG. 1 and a pool cleaner 200 of FIGS. 2A and 2B. The pool cleaners 100, 200 are designed to locate and remove debris from an aquatic environment 300, for example, a pool or a spa 301 of FIG. 3. The aquatic cleaning system, e.g., the pool cleaners 100, 200, may be provided in the form of an autonomous system, for example, a robot. The pool cleaners 100, 200 may implement control algorithms disclosed herein.

The pool cleaner 100 of FIG. 1 may include a housing 102 defined by one or more walls, a debris basket 104 coupled to the housing 102, which may be provided inside or at least partially inside of the housing 102. The debris basket 104 may be designed to receive debris from the aquatic environment 300. In some forms, the debris basket 104 may be provided externally to the housing 102. In additional examples, the housing 102 may have a plurality of walls, for example, a top wall, a bottom wall, a first side wall, a second side wall, a front wall, and a rear wall, that all form a generally rectangular shape. In other illustrative examples, the housing 102 may have any suitable number of walls and/or may have any suitable shape. While directional terminology is utilized herein (e.g., front, rear, forward, backward, etc.), such terminology is used to describe components or features in relation to one another and is not intended to be limited. For example, the walls may be described as being front and rear walls, but one skilled in the art will understand that the pool cleaner 100 is capable of moving in a first direction in which a front wall is facing a direction of travel, but the pool cleaner 100 may also be reversed such that a rear wall is facing a direction of travel.

The pool cleaner 100 may further include a drive system 106 operatively coupled to the housing 102 to move the housing 102. The drive system 106 may include a respective track 108, 110, on either side of the housing 102. The tracks 108, 110 may traverse an aquatic environment via elongate treads, tracks, or other components that facilitate locomotion. Additionally, the drive system 106 may include, for example, a plurality of axles, gears, and/or other components that are operatively connected to, for example, a motor that provides rotational energy to the axles, gears, and/or other components. In other examples, the pool cleaner 100 may be pressure or suction driven, in which case, the pool cleaner 100 may include a turbine or other fluid directing device that controls a flow of water through the pool cleaner 100 to rotate the tracks 108, 110. In other examples, the drive system 106 may include a plurality of wheels such as a set of front wheels and/or a set of rear wheels.

The pool cleaner 100 may further include a cleaning tool 112, e.g., a scrub brush, for cleaning and/or picking up objects. In some examples, the pool cleaner 100 may include one or more scrub brushes. The pool cleaner 100 may also include a cleaning tool 112 that assists with the movement of the pool cleaner 100. In some examples, debris and water are pulled through an inlet, and into a filter, which collects debris, and the water (without debris) is exhausted from the pool cleaner 100. In a further example, the pool cleaner 100 may include a debris bag (not shown), or other internal or external debris capturing element.

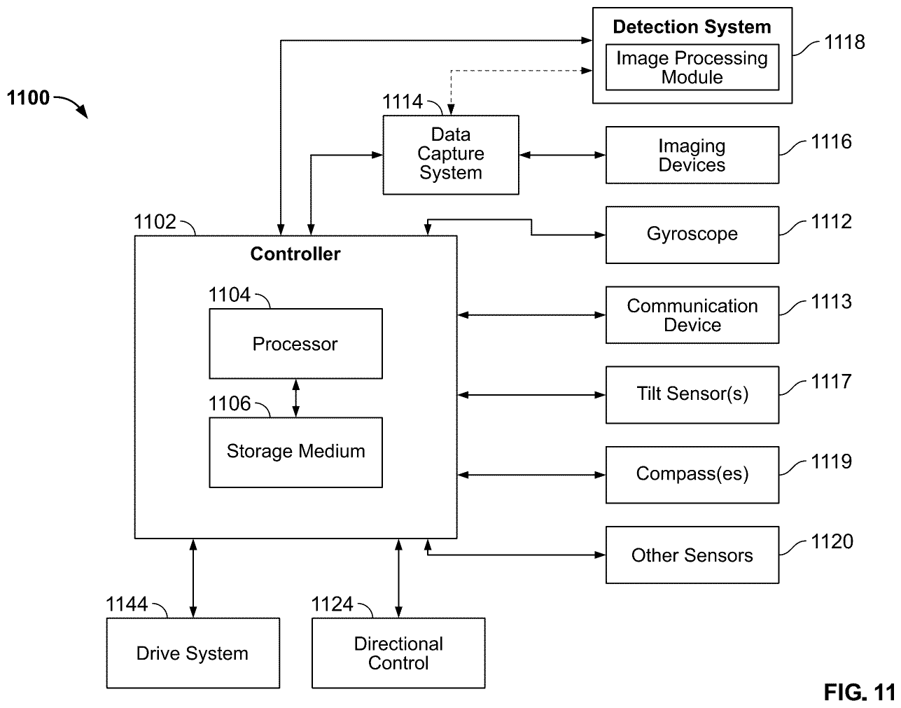

The pool cleaner 100 may include a control system 120 (e.g., control system 1100 of FIG. 11 as described below). In some instances, the control system 120 may be provided onboard the pool cleaner 100. In other instances, the control system 120 may be provided remotely via a wired or a wireless network connection, for example, on a user device (e.g., user device 310 of FIG. 3) or at a central terminal.

The pool cleaner 100 may further include a data capture system 114 and a detection system 118, which may each be communicatively and/or operatively coupled to the control system 120 of the pool cleaner 100. The data capture system 114 may include sensors for detecting objects, such as one or more imaging devices 116 for receiving images. The detection system 118 may be used to detect objects such as debris in an aquatic environment.

Turning to FIGS. 2A and 2B, the pool cleaner 200 may include a housing 202, a drive system 206 that may include one or more wheels 208, 210, a data capture system 214 that may include a plurality of imaging devices 216a, 216b, 216c, and 216d (collectively referred to as 216), a cleaning tool 212 such as a scrub brush, a debris basket 204, a detection system 218, and/or a control system 220 (see FIG. 2A). In some instances, the data capture system 214 and the detection system 218 of the pool cleaner 200 may be the same or substantially the same as the data capture system 114 and the detection system 118 of the pool cleaner 100 of FIG. 1, respectively, and may each be communicatively and/or operatively coupled to the control system 220 of the pool cleaner 200. Similarly, in some instances, the control system 220 may be the same or substantially the same as the control system 120 of FIG. 1. In some instances, the control system 220 may be provided onboard the pool cleaner 200 or may be provided remotely via a wired or a wireless network connection, for example, on a user device (e.g., user device 310 of FIG. 3) or at a central terminal.

In some instances, the one or more wheels 208, 210 may include at least one encoder 219 for measuring a distance traveled by the pool cleaner 200. The encoder 219 may be, for example, optical or magnetic. In some examples, an optical encoder may use a light source, like an LED, and a photodetector to track rotations of a disk with transparent and opaque sections, producing a series of pulses. In other examples, a magnetic encoder may detect changes in the magnetic field as a magnetized wheel or disk rotates, generating corresponding signals. Within both optical and magnetic encoders, the produced signals are processed by a microcontroller or processor, which counts the pulses and uses pre-calibrated data such as the wheel's circumference to calculate the total distance traveled. In some instances, the encoder 219 may operate by counting the number of wheel rotations and converting this data into linear distance using pre-calibrated wheel dimensions.

The travel distance measured by the encoder 219 may be used to map a shape and size of the aquatic environment 300. The mapping data may be further processed to identify obstructions or variations in the aquatic environment 300 (e.g., a pool or spa floor), enabling the pool cleaner 200 to optimize its navigation pattern or path. It should be appreciated that at least one encoder may also be included in the drive system 106 of the pool cleaner 100 of FIG. 1.

In some examples, the pool cleaners 100, 200 described in FIGS. 1, 2A, and 2B may include one or more gyroscopes, one or more tilt sensors, one or more compasses, one or more other sensors, for example, one or more accelerometers or inclinometers (see FIG. 11), or any other components that can provide feedback about the pool cleaners 100, 200 and/or the environment around the pool cleaners 100, 200.

With reference to FIGS. 1, 2A, and 2B, the control system 120, 220 of the pool cleaners 100, 200, respectively, may each include a controller (e.g., controller 1102), which is discussed in more detail with respect to FIG. 11. Communication between the elements of the control system 120, 220 may be provided to the user device (e.g., user device 310) via a network or directly, e.g., via a Bluetooth or Wi-Fi connection. The control system 120, 220 can operate one or more components of the pool cleaners 100, 200, respectively.

With further reference to FIGS. 1, 2A, and 2B, the data capture system 114, 214 may be designed to capture or otherwise receive images or other data associated with objects submerged within an aquatic environment via the imaging devices 116, 216 of the pool cleaners 100, 200, respectively. In some examples, the imaging devices 116, 216 may be mounted on the outer surface of the housing 102, 202 of the pool cleaners 100, 200, respectively. In other examples, the imaging devices 116, 216 may be mounted inside the housing 102, 202 of the pool cleaners 100, 200, respectively. In some instances, one or more imaging devices 116, 216 may be mounted on an arm or a handle of the pool cleaners 100, 200, respectively. For example, as shown in FIGS. 2A and 2B, the imaging device 216a may be mounted on arm 221 of the pool cleaner 200. The imaging devices 116, 216 may be provided in a waterproof case. In some instances, the imaging devices 116, 216 may be one or more cameras. In other instances, the imaging devices 116, 216 may be one or more image sensors. Data from the imaging devices 116, 216 may be processed via Raspberry Pi Compute Module 3 with custom written software for image processing. In other examples, one or more light sources (e.g., light source 222) may also be provided, for example, on an arm (e.g., arm 221), or elsewhere on the pool cleaners 100, 200 to provide illumination for the imaging devices 116, 216.

With continued reference to FIGS. 1, 2A and 2B, the detection system 118, 218 of the pool cleaners 100, 200, respectively, may include or be coupled to a storage medium, e.g., a memory, designed to store a trained model, and a processor designed to receive a plurality of data elements from the data capture system 114, 214 and input the plurality of data elements into the trained model to identify a detected object within the aquatic environment as being debris or non-debris. Additionally, the detection system 118, 218 may be communicatively coupled to the control system 120, 220 of the pool cleaners 100, 200, respectively, and/or the data capture system 114, 214. In some instances, the detection system 118, 218 and/or the data capture system 114, 214 may be contained within a controller (e.g., controller 1102 of FIG. 11) of the control system 120, 220.

It will be appreciated by those skilled in the art that while the pool cleaner 100 of FIG. 1 and the pool cleaner 200 of FIGS. 2A and 2B may include different elements, the respective elements of the pool cleaners 100, 200 may be interchanged or combined to form an additional pool cleaner not explicitly described. Numerous examples, elements, uses, and modifications of the pool cleaners 100, 200 may be combined to disclose an additional example that are intended to encompass the claims attached hereto.

FIG. 3 illustrates an aquatic environment system 300. In some instances, the aquatic environment 300 may be provided in the form of a pool or a spa 301 and include components that may be used with a pool and spa system. In yet other instances, the aquatic environment 300 may be provided in the form of pool and/or spa components designed for use with a pool and/or a spa in a residential setting or a commercial setting. More particularly, the aquatic environment 300 may be provided as a swimming pool, a hot tub, a spa, a plunge pool, and other recreational water venues not specifically discussed herein.

The aquatic environment 300 may include a pool cleaner 302, a network 308, a user device 310, a docking station 312, a communication device 313, and one or more pool components 326. The pool cleaner 302, the network 308, the user device 310, the docking station 312, the communication device 313, and/or the one or more pool components 326 may be communicatively and/or operatively coupled to one another or additional elements described herein.

In some instances, the pool cleaner 302 may be the pool cleaner 100 of FIG. 1, the pool cleaner 200 of FIGS. 2A and 2B, or a combination thereof, and may include the same or similar components as the pool cleaners 100, 200. For example, the pool cleaner 302 may include a drive system 306 (e.g., drive system 106 or 206), a data capture system (e.g., data capture system 114 or 214), one or more imaging devices (e.g., imaging devices 116, 216), and a detection system (e.g., detection system 118 or 218).

In some instances, the one or more pool components 326 may include plumbing (e.g., conduits) and one or more pool management tools. The one or more pool components 326 may include one or more of an inlet conduit, a variable speed pump, a booster pump, a filter, a heater, a sanitizer, a water chemistry monitor, a water feature, a water chemistry regulator, one or more valves, one or more discharge conduits, a pool skimmer, and one or more refill devices. The one or more pool components 326 may be located on a pool pad.

Still referring to FIG. 3, the aquatic environment 300 can further include a central controller or a control system (e.g., control systems 120, 220). The user device 310 may interface with the central controller or control system either directly over a local area network or via a cloud network (e.g., network 308). The central controller or a control system can be a gateway, a hub, a switch, a router, a server, a switch, or other connection device to allow integration, monitoring, and control of multiple aspects of the aquatic environment 300. The user device 310 can be provided in the form of a cell phone, tablet, laptop, or any other similar portable electronic device that may include a camera and a user interface.

Additionally, as shown in FIG. 3, the pool cleaner 302 may have a field of view 307 in which various objects may be located. The objects may include: debris 318, e.g., leaves or sticks; a non-movable non-debris object 320, e.g., a drain or an in-floor cleaning pop-up head; a manufactured and/or other moveable non-debris objects 322, e.g., a toy, or other valuable 324, e.g., jewelry, such as a ring, necklace, or bracelet. The control system (e.g., control system 120, 220) of the pool cleaner 302 may operate the drive system 306 to move the pool cleaner 302 along a navigation path 304 toward the detected object identified by the detection system (e.g., detection system 118, 218). In some instances, the drive system 306 moves the pool cleaner 302 only when the detected object is identified by the detection system as being debris.

The navigation path 304 may be determined by the view plane of the imaging devices (e.g., imaging devices 116, 216) located on the pool cleaner 302. More specifically, the view plane of the navigation path 314 may represent the area observable by the imaging devices at any given time. Within some examples, the imaging devices may be configured to adjust their view planes dynamically, creating either an extended view plane that broadens the navigation path 304 bounds, thereby allowing the pool cleaner 302 to perceive and operate across a wider area, or a narrowed view plane that restricts the bounds of the navigation path 304, enabling focused operation in specific regions. Such adjustments to the view plane may be made in response to changing environmental conditions or specific cleaning requirements. The direction of travel of the pool cleaner 302 may also be determined by the navigation path 304 or alternatively dictated by the real-time modifications to the view planes of the imaging devices 116, 216.

Still referring to FIG. 3, the network 308 may include, for example, the Internet, intranets, extranets, wide area networks (“WANs”), local area networks (“LANs”), wired networks, a coaxial cable data communication network, an optical fiber network, a direct wired serial communication connection (e.g., USB), wireless networks, such as a Wi-Fi network, a radio communication network, a cellular data communication network (e.g., 4G, 5G, LTE, etc.), a direct wireless communication connection (e.g., Bluetooth, NFC, etc.), or other suitable networks, or any combination of two or more such networks. For example, such networks can include satellite networks, cable networks, Ethernet networks, and other types of networks. In some examples, the network 308 may be a private network (e.g., a private LAN), a public network (e.g., the Internet), or a combination of private and/or public networks. If a detection system and/or a control system are not included within the pool cleaner 302, a communication access may be provided via the network 308, the user device 310, and/or the communication device 313.

Although FIG. 3 depicts a pool cleaner 302 in communication with the user device 310, the communication device 313, the docking station 312, the one or more pool components 326, and the network 308, it should be noted that various communication methodologies and connections may be implemented to work in conjunction with, or independent from, one or more local controllers associated with one or more individual components associated with the aquatic environment 300 (e.g., the one or more pool components 326). For example, one or more of the central controller and the local controllers may utilize a Local Area Network (LAN), a Wide Local Area Network (WLAN), Narrowband Internet of Things (NB-IoT), Long-Term Evolution for Machines (LTE-M), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information.

The communication device 313 of FIG. 3 may be provided in the form of an antenna, which may float on the surface of the water and may be wired or wirelessly connected to the pool cleaner 302 or may have a wired connection 315 to the pool cleaner 302. Alternatively, the communication device 313 may be coupled directly to the pool cleaner 302 such that the communication device 313 may be below the water line of the water in the pool or spa 301 when the pool cleaner 302 is submerged. Communication to/from the pool cleaner 302 may also be provided via a docking station 312, which may be wirelessly connected to the pool cleaner 302. The docking station 312 may be located inside or near the aquatic environment 300 and may be a charging station for the pool cleaner 302, as well as a communication access point for the pool cleaner 302. Communication between the communication device 313, the network 308, the user device 310, the docking station 312, and/or the one or more pool components 326 may be provided via, for instance, Wi-fi, Bluetooth, Bluetooth Low Energy (BLE), 900 MHZ, and/or an infrared (IR) or radio frequency (RF) transmitter(s)/receiver(s) or transceiver(s).

In other examples, the communication device 313 may be a Wi-Fi or radio frequency antenna capable of communication between the pool cleaner 302, the network 308, the user device 310, the one or more pool components 326, or other elements described within the aquatic environment 300. These components may include various sensors, heaters, or filtration systems that can be controlled remotely as described above. In some examples, the pool cleaner 302 may be capable of communicating with various devices within the aquatic environment 300 (e.g., the pool components 326). Communication may be by radio frequency, Wi-Fi, or ethernet.

In some instances, the pool cleaner 302 may be capable of breaching the pool or spa 301 water surface to establish a Wi-Fi, radio, or another communication connection. By breaching the water surface, the pool cleaner 302 may transmit or receive data and updates without manual intervention. For example, after a certain amount of cleaning time (e.g., at or about 30 minutes, at or about 1 hour, at or about 1.5 hours, at or about 2 hours, etc.), the pool cleaner 302 may rise to the surface of the water, exposing the communication device 313 and/or the controller above the surface of the water to establish a communication connection. When connected, the pool cleaner 302 may be used to send data and notifications to the user device 310, update the cleaning schedule, or perform diagnostics on the pool cleaner 302.

In other examples, the pool cleaner 302 may be capable of transmitting information and data to a plurality of pool elements (e.g., the pool components 326) within the aquatic environment 300 to provide real time feedback and status of the pool or spa 301. In some examples, the detection system may be capable of transmitting data about the debris within the pool or spa 301 and other aspects of the pool or spa 301 to the one or more pool components 326, such as a pool pump, heater, sanitizer. For example, if the water in the pool or spa 301 is murky or cloudy, the pool cleaner 302 may send an alert or other notification to a pool pump to increase circulation of the water or to a sanitizer to adjust the chemicals being dispensed into the water of the pool or spa 301. Additionally, the pool cleaner 302 may be able to provide information about the pH or temperature of the water in the pool or spa 301 and send an alert or other notification to a sanitizer to increase or decrease the amount of chemicals being dispensed and/or a heater to increase or decrease the temperature. In other embodiments, the pool cleaner 302 may send alerts or other notifications regarding aspects of the pool or spa 301 to other elements within the aquatic environment 300 such as the network 308 or the user device 310 to provide a status or other information about the aquatic environment 300.

Further, as described above, the pool cleaner 302 may include the detection system 118, 218. The detection system 118, 218 may be used to identify objects. In some instances, the detection system 118, 218 may be used to by the pool cleaner 302 to avoid the identified non-debris objects, not collect the identified non-debris objects, ignore the identified non-debris objects, send a notification, (e.g., send a notification to the user via the user device 310) related to the identified non-debris objects, and/or collect the identified non-debris objects. Some examples of the non-debris objects include a drain, a toy, jewelry, an owner's possession, or a manufactured object. If the non-debris object is collected by the pool cleaner 302, the non-debris object may be collected into the debris basket or into a separate container. If the non-debris object is collected into the debris basket, a notification may be sent to alert a user that there is non-debris in the basket or separate container, for example, so that the user can check the debris basket or separate container to retrieve the non-debris object before disposing of the debris. The notification may be sent to the user device 310 via any appropriate communication method, for instance, a program or application on the user device 310 that is associated with the pool cleaner 302, a short message service (SMS) or multimedia messaging service (MMS) message, an email, an indicator light on the cleaner 302, or at another known location, an alert on a display (e.g., tablet, television, phone, computer, or similar), an audiovisual alert, a light notification, a haptic notification, an audio notification, and voice announcement, a push notification on the user device 310 or central terminal, and/or similar notification or alert. If the debris is part of the pool or spa 301, e.g., a drain, then the pool cleaner 302 may ignore or avoid the detected object. Ignoring the detected object may include the pool cleaner 302 moving around the detected object or traveling over the object, which may include scrubbing along with the environment surface, as if the object were not there.

In one instance, the detection system 118, 218 may include an image processing module (see FIG. 11) designed to receive images in the form of a plurality of data elements from the data capture system 114, 214. In some instances, the detection system 118, 218 may receive data from the data capture system 114, 214 directly; in other instances, the data from the data capture system 114, 214 may be received via the control system 120, 220. The image processing module may be designed to process the images to clarify at least one object in the image. For example, the plurality of data elements may include a high-resolution image, for example, received from any of imaging devices 116, 216. In some instances, the detection system 118, 218 may determine a size of a detected object using an image box or envelope processing method on the received image. In some instances, the training model may include an image library designed to determine a type of detected object. For instance, the image library may include images related debris and non-debris, for example, a leaf, a stick, jewelry, a toy, a ring, a necklace, a bracelet, a fixed object, a drain, and an in-floor cleaning pop-up head. In one instance, machine learning uses the training model to classify detected objects. For instance, the classifications may include identifying debris versus non-debris and may further include classifying the types of non-debris (e.g., movable or non-movable). In one example, different actions may be taken by the control system 120, 220 based on what type of debris is identified, and a different action may be taken for different pieces of debris identified in the aquatic environment. It should be appreciated that the image processing and/or object classification may be performed onboard the pool cleaner 302 or remotely, e.g., at the user device 310, a central terminal, or on the network 308. It should be appreciated that, if the image processing and/or object classification are performed onboard the pool cleaner 302, the data capture system 114, 214 and the detection system 118, 218 may be combined and/or coupled.

In some instances, the pool cleaner 302 may include a local learning model operating on the pool cleaner 302 (for example, as part of the control system) and a remote learning model operating on the network 308. The remote learning model may be housed on a central server or a cloud within the network 308. The local learning model and the remote learning model may be capable of storing various parameters (weights and biases) of the respective system model. The parameters may be capable of adjusting the model's response to input data, such as pixel values in images. As an example, the parameters may be determined through backpropagation, an iterative optimization technique that minimizes errors by adjusting the parameters based on a loss function (e.g., the difference between the model's predictions and the true values). Additionally, the remote learning model may include a larger number of parameters compared to the local learning model.

Additionally, during operation, the pool cleaner 302 may periodically synchronize its local learning model with the remote learning model located on the network 308. This may be done though a wired or wireless communication from the control system (e.g., control system 120, 220) of the pool cleaner 302, the communication device 313, the docking station 312, the user device 310, and/or the one or more pool components 326. The synchronization may allow the local learning model to update and incorporate refinements made to the remote learning model's parameters (weights and biases) without requiring the entire dataset to be processed locally. In some aspects, the remote learning model may maintain a significantly larger set of parameters compared to the local learning model. For example, the remote learning model may include about 10 gigabytes whereas the local learning model only includes around 1 gigabyte. The variation between the local and remote learning models allows the local learning model to maintain responsiveness and energy efficiency while leveraging the remote learning model for tasks requiring greater computational depth. Furthermore, the local learning model may perform pre-processing or down sampling of image data before transmitting it to the remote learning model, thereby reducing bandwidth usage and enhancing overall system efficiency.

In some examples, the local learning model on the pool cleaner 302 may first attempt to process incoming image data autonomously, such as distinguishing between small debris and larger obstructions. For scenarios where the local model encounters ambiguities or limitations (see example below), it may escalate the image data, along with preliminary processing results, to the remote learning model for further analysis. This cooperative framework may enhance accuracy and robustness of image processing while allowing the pool cleaner 302 to adapt to various cleaning environments. Additionally, by distributing the workload between the local and remote learning models, the system may achieve a balance between computational efficiency and thoroughness in analyzing a pools condition.

As an example, the pool cleaner 302 may be capable of communicating with the network 308 of FIG. 3 when mapping the aquatic environment 300. If the local learning model of the pool cleaner 302 cannot identify the type of debris, the pool cleaner 302 via the detection system or controller may communicate with the remote learning model of the network 308, which may be capable of identifying the unknown debris. For example, the pool cleaner 302 may identify an unknown item within the pool 301 such as a shoe. The pool cleaner 302 may then transmit the detected object (e.g., the shoe) to the network 308 where the shoe may be identified as a movable non-debris. In some examples, the pool cleaner 302 includes a set amount of training data to identify debris within the pool or spa 301. In some aspects, the pool cleaner 302 may transmit the unknown debris, via one or more images or other data, to the network 308 and/or the remote user device 310.

In one instance, the data capture system 114, 214 may include one or more ultrasonic sensors. Ultrasonic sensors typically operate at frequencies ranging from 20 kHz to several megahertz, with higher frequencies offering finer resolution at the expense of a shorter detection range. The ultrasonic sensors may operate by emitting high-frequency sound waves and measuring the time it takes for the sound waves to reflect back from an object. In some instances, the emitted sound waves form a conical detection field, influencing its ability to detect objects at varying angles and distances. Higher frequency sound waves provide better resolution for detecting smaller objects, while lower frequencies allow for greater range in deeper waters. To maintain accuracy in diverse environments, the ultrasonic sensors may employ temperature compensation mechanisms to account for variations in the speed of sound caused by changes in the surrounding medium's temperature. In some examples, the ultrasonic sensors within the data capture system 114, 214 may incorporate techniques like beamforming and signal processing to enhance detection and accuracy in a challenging environment. Beamforming, achieved through phased arrays, may allow the system to focus the ultrasonic waves in specific directions, thereby improving resolution and reducing interference. Advanced algorithms in the control system 120, 220 or the data capture system 114, 214 may filter out background noise and analyze multi-path echoes to differentiate between closely spaced objects.

Additionally, the control system 120, 220 may be further designed to use inputs from the one or more ultrasonic sensors to determine a distance to the detected object and to determine a size of the detected object based on the determined distance and/or based on the image box or envelope processing method performed by the detection system 118, 218. In some examples, the control system 120 may implement advanced mathematical models, such as time-domain reflectometry, frequency modulation techniques or machine learning models, to enhance distance and size calculations. Ultrasonic sensors may also be capable of detecting objects regardless of lighting conditions or object transparency within the underwater environment, thus enabling detection in murky or low-visibility conditions. The navigation path 304 may be determined based on a distance between a detected object and the cleaner 302. The distance to the object may be determined or derived from the object size and a time of flight (ToF) utilizing the one or more ultrasonic sensors. Furthermore, ultrasonic ToF calculations may be enhanced by using sophisticated interpolation algorithms, which reduce measurement errors caused by environmental noise. Additionally, ultrasonic sensors may detect soft or irregularly shaped objects that may not reflect light well, enhancing their utility in dynamic scenarios. The detection system 118, 218 may also include multi-frequency ultrasonic sensors to dynamically adjust frequency for optimal detection of objects with varying acoustic impedance. Light sensors or other appropriate sensors may also be provided to aid in the location and navigation of the cleaner 302.

As the cleaner 302 moves along the surface of the aquatic environment 300, e.g., a pool or spa 301, the detection system 118, 218 and/or control system 120, 220 may use machine learning to self-learn the mapping of the environment and improve on the classification and detection algorithms and trained models. The mapping of the aquatic environment may include, for instance, determining a size and shape of a bottom and/or each sidewall of the pool or spa 301, locating non-moveable features, such as the drain and docking station 312, and identifying any contours or surface irregularities of the cleanable surfaces, e.g., bumps, slopes, integrated seats, steps, or other features.

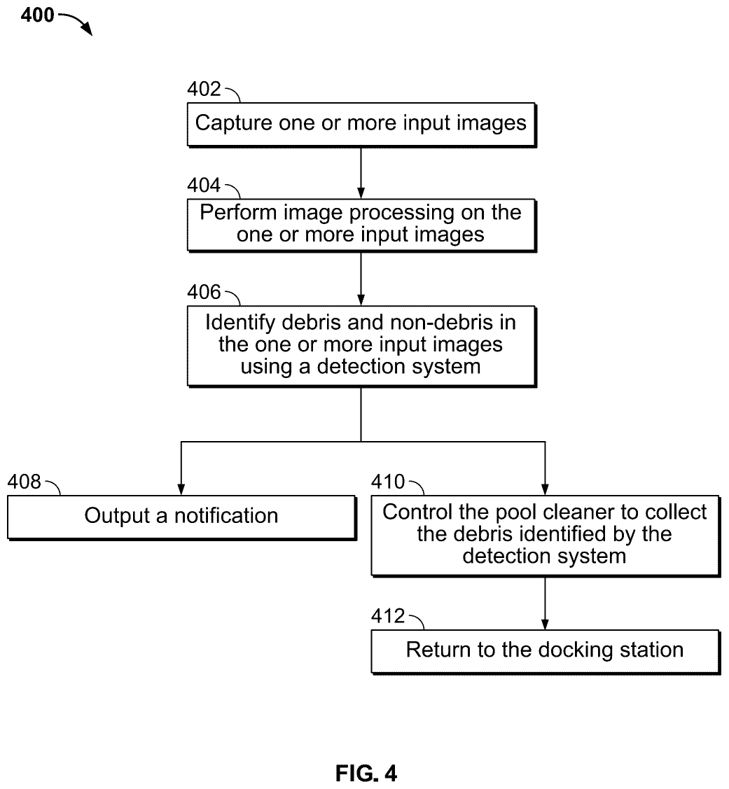

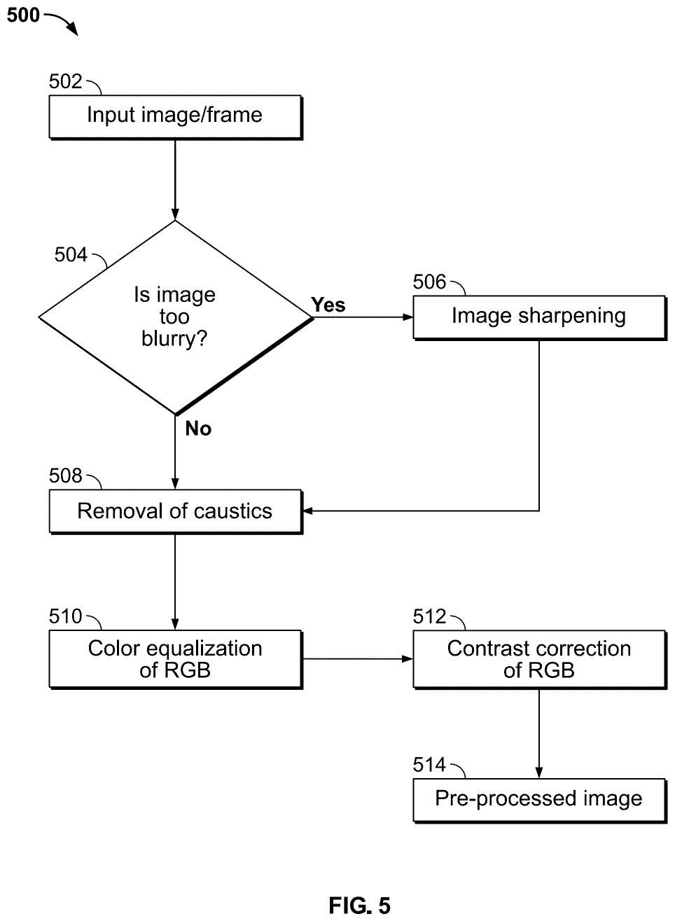

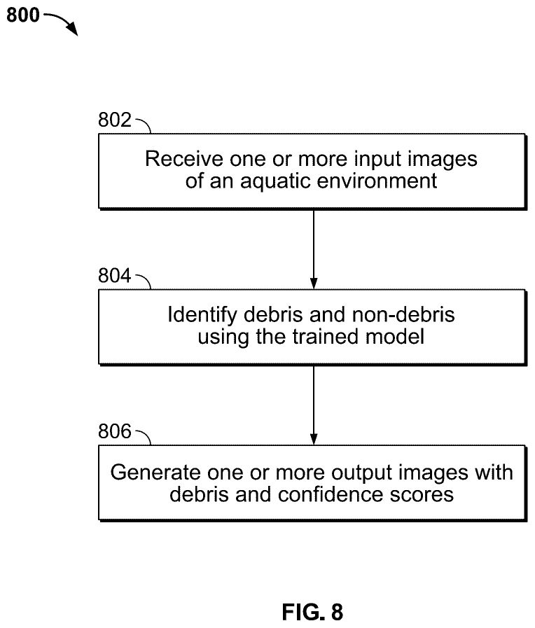

FIG. 4 depicts a flow chart illustrating a method 400 for operating a cleaning system, e.g., any of the pool cleaners 100, 200, 302 of FIGS. 1-3, for an aquatic environment (e.g., aquatic environment 300). The method 400 may include an operation 402 to capture or obtain one or more input images, for instance, by the data capture system 114, 214. In some instances, the data capture system 114, 214 obtains the images or other image data from the one or more imaging devices 116, 216. At an operation 404, image processing may be performed on the one or more input images (see, e.g., FIG. 5), for instance, by the detection system 118, 218. In some instances, the image processing on the one or more input images may use computer algorithms to clarify at least one object within the image. At an operation 406, debris and non-debris may be identified in the one or more input images using a detection system, for example, the detection system 118, 218. In some instances, the debris and non-debris will be identified using a trained machine learning model (see, e.g., FIG. 8).

At operation 408, the cleaning system may optionally output a notification. In some instances, the notification will be sent if the debris basket is full or if non-debris is detected. At operation 410, the cleaning system may control the pool cleaner to move the pool cleaner, for example, to avoid or ignore the non-debris or to collect the debris identified by the detection system. The cleaning system may also collect movable non-debris and send a notification related to the non-debris collected. After the pool cleaner is moved, the battery is low, and/or finishes a cleaning operation, it may return to its docking station (e.g., docketing station 312) at operation 412 for storage and/or recharging.

FIG. 5 is a flow chart illustrating an image processing method 500 for a cleaning system for an aquatic environment according to an example. Light and color behave differently underwater than in air, which may affect the quality and visibility of images received from the imaging devices of the data capture system 114, 214. For example, with light refraction, light refracts as it enters the body of water due to the higher density of water relative to air. Random light diffusion can also affect image quality. As light enters water with a wavy surface, e.g., under windy conditions, the light may be diffused randomly in water, which may cause uneven lighting conditions (e.g., light spots) on the floor and sidewall surfaces of the swimming pool. Water absorbs light at different rates. Objects and the environment become bluer and greener because water absorbs red, indigo, and violet light rays at a higher rate than blue or green, thus causing a color shift, especially at greater depths. With backscatter, suspended particles in water cause the light to reflect back from particles in the lens's field of view causing specks of light to appear in the photo. Crinkle patterns and Raleigh scattering can also negatively affect image quality underwater.

Computer vision is known to use various processes to offset problems caused by underwater image collection. For example, blurriness, e.g., caused by there not being enough light or suspended water particles, may be sharpened using pre-processing. Strobes (e.g., artificial lights, flash) may also reduce the blurriness, for instance, using the light source 222 of FIGS. 2A and 2B. Imbalanced illumination may cause degradation in visibility & low contrast. The amount of sunlight reduces as the water gets deeper such that only a portion of light from the objects reaches the imaging device and the remaining light gets scattered while traversing the path through the water medium.

Using a strobe, flash, or other artificial light, e.g., the light source 222 of FIGS. 2A and 2B, can be useful in illuminating objects and can increase the visibility conditions. Contrast can be increased by using image processing algorithms, such as histogram equalization, histogram stretching, and the like. Color shift can be caused, for example, by red and orange colors getting absorbed faster than other colors in water. This can be remedied by use of a color filter covering the lens of the imaging device, a strobe, or flash, e.g., the light source 222 of FIGS. 2A and 2B, or white balancing. The color filter and/or white balancing can be applied, for instance, by the data capture system 114, 214 or as part of processing by the detection system 118, 218. Backscatter, light absorption, reflection, and diffusion, effects of ripples on the water, and other noise can be compensated for through hierarchical preprocessing stages, physical filters covering the lens of the imaging device, and/or a strong strobe light. Software hierarchical preprocessing may be the most effective and least costly solution. These various defects caused by the environment may be referred to as “caustics.”

As illustrated in FIG. 5, in an image processing method 500, an image or frame, e.g., from a video, may be input or received, e.g., from the data capture system 114, 214 to the detection system 118, 218, in operation 502. In operation 504, a determination is made as to whether the image is too blurry. Blurriness may be assessed using algorithms that analyze the sharpness of edges within the image. For instance, the Laplacian method may be employed to measure the variance of the Laplacian, with a low variance indicating a blurry image. If “Yes”, then an image sharpening operation 506 is performed. Image sharpening techniques, such as unsharp masking or high-pass filtering, may enhance the clarity of the image by amplifying high-frequency components. If “No”, then one or more caustics are removed in operation 508. As an example, caustics, which are bright patterns formed by the focusing of light, can distort image quality and are typically addressed using reflection removal techniques.

Additionally, in operation 510, color equalization of red, green, and blue (RGB) colors may be performed. Step 510 may ensure that the color distribution in the image is balanced, which can be achieved using histogram equalization methods to spread out the most frequent intensity values. In operation 512, contrast correction of the equalized RGB colors may be performed. Contrast correction may adjust the difference in luminance and color that makes an object distinguishable. Techniques such as contrast stretching or adaptive histogram equalization may be used to improve the contrast of the image. Next, a pre-processed image ready for object identification may be generated from the contrast-corrected image in operation 514. The pre-processed image is now optimized for further analysis, such as real-time object detection algorithms like YOLO (You Only Look Once) or Faster R-CNN (Region-based Convolutional Neural Networks). It should be appreciated that image capture is not limited to RGB imaging. Other imaging modalities, such as infrared or multispectral imaging, can also be utilized depending on the application requirements.

As an example, an object detection algorithm such as YOLO identifies and classifies various elements such as debris, algae, and various pool surfaces. The algorithm divides each image into a grid and predicts bounding boxes and probabilities for multiple objects in a single pass, making it highly effective for real-time detection and navigation. For example, as a cleaner moves, YOLO can distinguish between leaves and other debris, enabling the cleaner to focus on areas that require more attention.

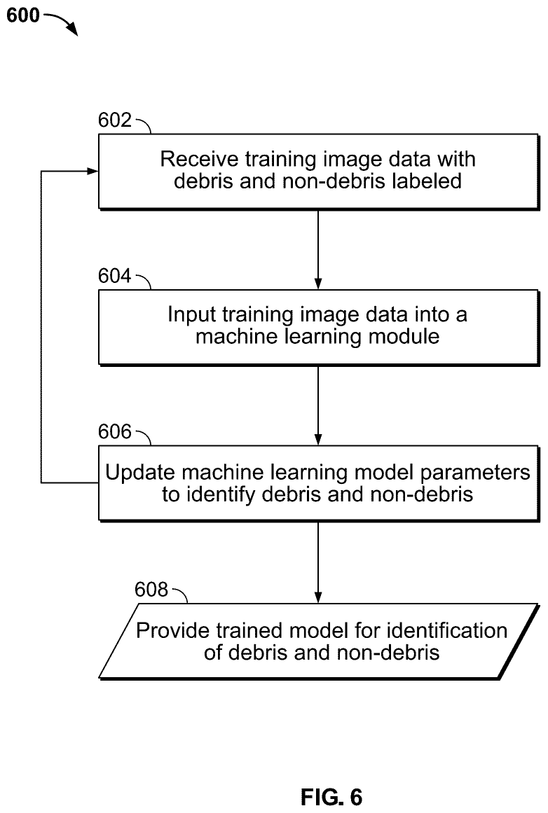

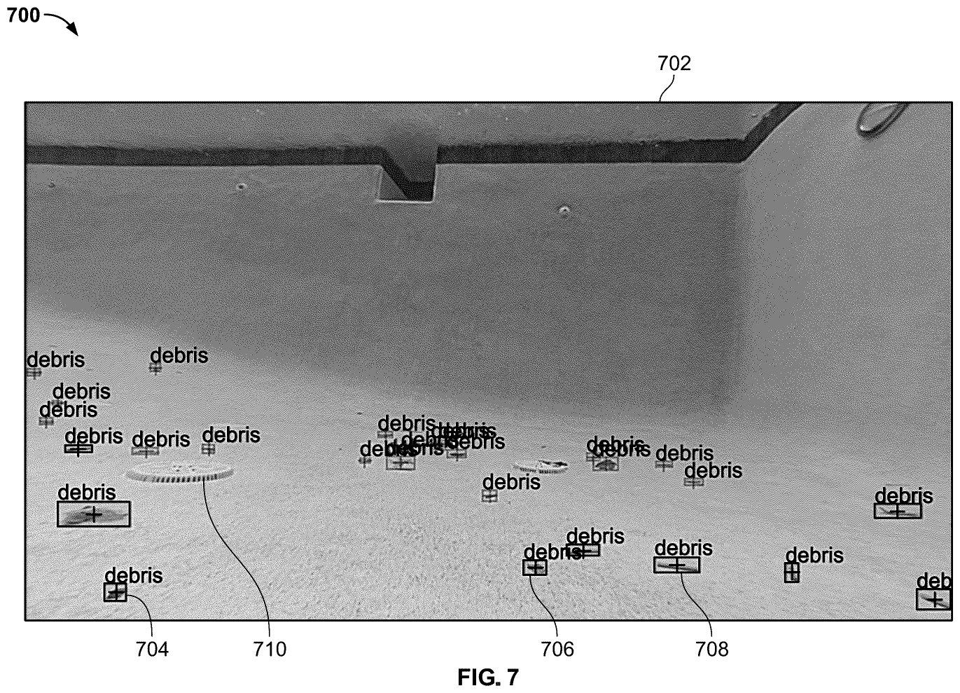

With reference to FIGS. 6 and 7, FIG. 6 illustrates a method 600 for generating a trained model for operating a cleaning system. The method 600 may receive training image data, e.g., an annotated image 700 (see FIG. 7), with debris and/or non-debris labeled in an operation 602. An annotated image may allow the user to provide the ground truth for the machine learning algorithm and ensure accurate training for the model. Annotated images also allow a user to see and help the model identify correct and incorrect predictions. The annotated image 700 may be provided to the detection system, e.g., the detection system 118, 218, for training the trained model. The detection system 118, 218 may utilize these annotations to learn to differentiate between various objects within the aquatic environment. The training image data may be input into a training module in an operation 604. Various objects may be annotated and identified from an original image 702 of an aquatic environment, and/or classified as debris, e.g., debris 704, 706, 708. For instance, debris may include leaves, twigs, or other foreign particles that disrupt the pool's cleanliness. Other objects may be identified and/or classified as non-debris, e.g., drain 710. Identified objects may be classified, for example, as debris or non-debris, and then further sub-classified. This detailed classification helps the system prioritize cleaning tasks based on the type and severity of debris.

For instance, debris can be classified by size, shape, type, density, cleanability, priority, danger, or any other useful category. Smaller, less dense debris might be categorized as low priority, while larger, hazardous items are marked for immediate removal. As another example, non-debris can be classified by size, shape, type, moveability, value, as part of the environment, priority, or any other useful category. Objects like pool toys can be marked as moveable non-debris, ensuring they are not mistakenly targeted for cleaning. A trained model may be developed in an operation 606 to identify debris and non-debris. This trained model is continually improved through iterative training cycles to enhance its accuracy and reliability. The trained model may be generated for the identification of debris and non-debris in an operation 608. Ultimately, this model allows for the automated cleaning system to operate with minimal human intervention, providing a consistent and thorough cleaning experience.

Now turning to FIG. 8, FIG. 8 illustrates a method for operating the cleaning systems of FIGS. 1-3. The method 800 includes an operation 802 of receiving one or more input images of an aquatic environment, an operation 804 of identifying debris and non-debris using the trained model, and an operation 806 of generating one or more output images with debris and confidence scores. Within operation step 802 the input images may be captured or obtained using imaging devices 116, 216 or other imaging devices, providing detailed visual data of the pool area. The operation 804 of identifying debris and non-debris using the trained model may use the model trained using the method 600 of FIG. 6 and the annotated image 700 of FIG. 7, as described hereinabove. In operation 804 of identifying debris and non-debris using the trained model, the trained model, developed using annotated images, utilizes advanced machine learning algorithms to accurately distinguish between different objects in the aquatic environment. For instance, it can identify leaves, twigs, and other debris, as well as non-debris objects like pool tiles or fixtures. Within operation step 806, generating one or more output images with debris and confidence scores is executed. Confidence scores indicate the algorithm's certainty in its classification of the debris, providing information for further processing and/or decision-making. In some instances, a cleaning pathway or navigation path 304 may be determined or assigned, for example by the control system 120, 220, based on the type of the identified debris and/or the one or more confidence scores. In other instances, the control system 120, 220 may navigate the pool cleaner 100, 200, or 302 to a determined cleaning pathway or navigation path 304 based on the type of the debris and/or the one or more confidence scores.

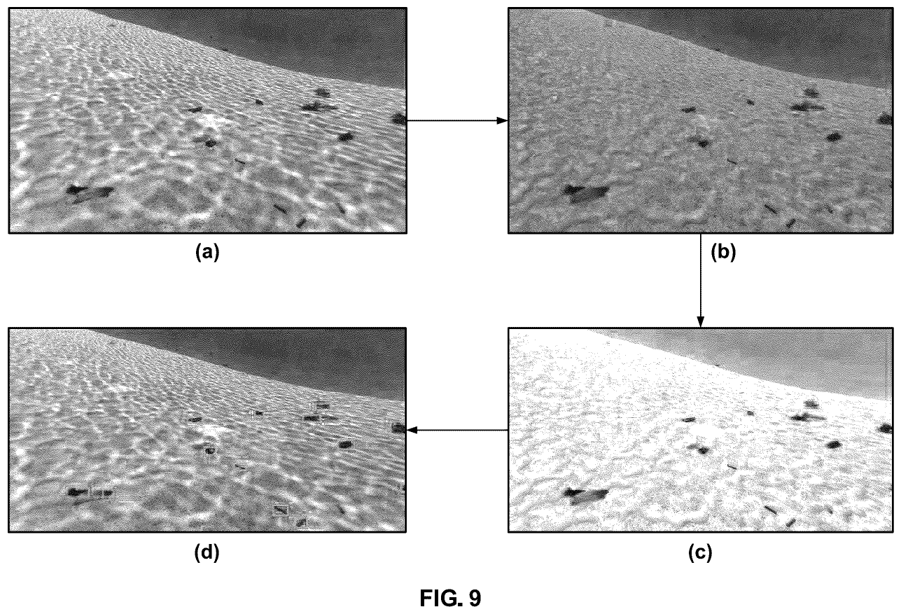

FIG. 9 is a process diagram illustrating an image processing method for a cleaning system for an aquatic environment according to an example embodiment. Part (a) depicts an original image as captured by an imaging device, e.g., any of imaging devices 116, 216 of FIGS. 1-2B, of a data capture system, e.g., the data capture system 114 of FIG. 1 or the data capture system 214 of FIG. 2. Part (b) shows a first-level processed image after one or more caustics are removed, e.g., after operation 508 of FIG. 5. Part (c) shows a second-level processed image after color and contrast correction, e.g., after operations 510 and 512 of FIG. 5. Part (d) depicts detection of objects as indicated by rectangles around the objects. In one instance, Otsu's method for thresholding may be used to perform automatic image thresholding to avoid false detection of objects in the image.

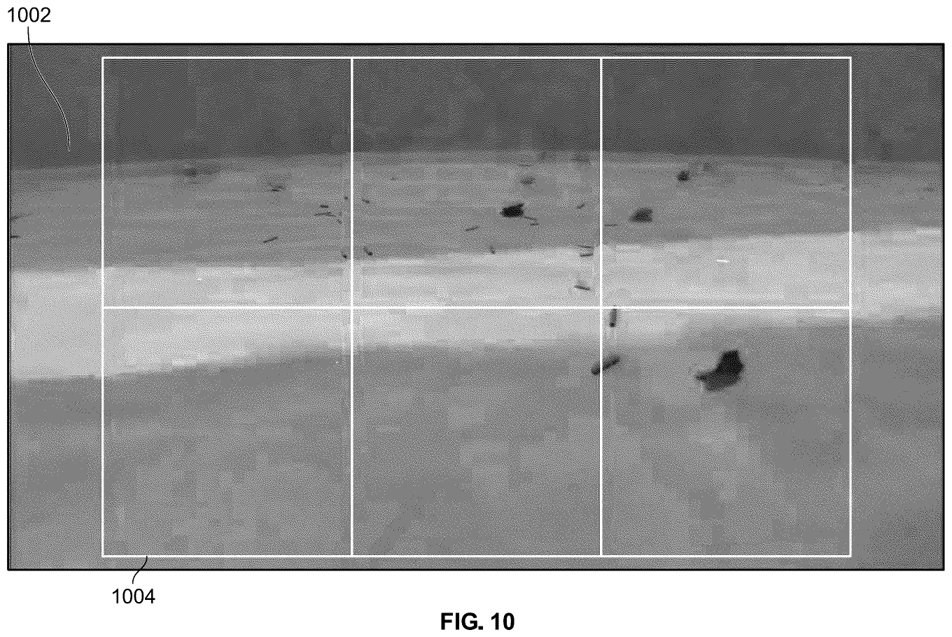

FIG. 10 is an image illustrating an image processing operation for an aquatic environment according to an example embodiment. A high-resolution image 1002 may be divided into smaller sub-images via a grid 1004. Each section of the grid 1004 may be processed separately to identify debris and non-debris therein. Such processing allows for finer resolution of the field of view to identify smaller objects. The high-resolution image 1002 may be, for example, a 1080p image, e.g., 1920×1080 pixels. Each section of the grid 1004 may be sized, for example, to 300×300 pixels.

In creating the trained model for identifying and classifying objects, a collection of images and videos was made. Five sites were visited with different swimming pools, different flooring types (e.g., Gunite, fiberglass, blaster, above ground, and inground), and different background (e.g., flooring) colors. Videos and images were collected and recorded in nine different swimming pools and weather conditions (e.g., rain, sunny, and windy). An off-the-shelf robotic cleaner with an imaging device was used to take videos and collect images. Videos were recorded from four different angles/points of view (e.g., front, back, left, and right) from each run. Over 11,000 pictures were generated and annotated of different debris and scenarios that can be present in a swimming pool, although more were added later to further train the model.

The TensorFlow® machine learning framework was selected. YOLOv3® was selected as an object detector model, e.g., as a base model, to train new objects (e.g., debris). In other examples, different models may be used including a full-coverage convolutional network (“FCCN”), MobileNetSSDv2™, and YOLOv2®. The Amazon Web Services® (AWS) Virtual Machine (VM) with a graphical processing unit (GPU) instance was used to allow machine learning on the cloud. The TensorFlow® framework was installed with all software/libraries used for the machine learning according to an instance of the present disclosure. Machine learning may include, for example, deep learning, artificial intelligence, a linear statistical model, a non-linear model, a logistic regression, a neural network, computer vision, other processing models, other modeling and analysis techniques, or a combination thereof. In certain examples, the one or more models are created or otherwise trained using AlexNet, GoogLeNet, Cognex®, or other available neural networks, training software, or software packages.

FIG. 11 depicts an exemplary control module or system 1100 (e.g., the control system 120 of FIG. 1 or the control system 220 of FIG. 2) for use with the pool cleaners 100, 200, 302 described herein. The control system 1100 may include a controller 1102 having a processor 1104 and a storage medium 1106 (e.g., memory) capable of controlling operation of the pool cleaners 100, 200, 302. Additionally, the control system 1100 may include a plurality of devices communicatively coupled to the controller 1102 including, a gyroscope 1112, a communication device 1113 (e.g., communication device 313), a data capture system 1114 (e.g., data capture system 114, 214), one or more imaging devices 1116 (e.g., imaging devices 116, 216) coupled to the data capture system 1114, a tilt sensor 1117, a detection system 1118, one or more compasses 1119, and/or one or more other sensors 1120. In some instances, the detection system 1118 may include an image processing module. The image processing module may be designed to execute one or more image processing methods, for example, the method 500 illustrated in FIG. The control system 1100 may also include a drive system 1144 and a directional control system 1124 to control operation of a pool cleaner 100, 200, 302. It should be known that one or more devices described herein with respect to the control system 1100 of FIG. 11 may be implemented. Additionally, the control system 1100 may also include only a select number of devices described, thus omitting from all of the devices illustrated within FIG. 11.

One or more control algorithms may be implemented within the control module or system 1100 and may operate one or more features and/or components of the pool cleaner (e.g., pool cleaner 100, 200, 302) and/or the control module. The control module or system 1100 may receive feedback from one or more components to operate the control algorithms to operate the pool cleaner 100, 200, 302 or to operate other components, functions, and/or features of the pool cleaner 100, 200, 302 such as the data capture system 1114 or the detection system 1118 (e.g. detection system 118, 218).

The controller 1102 may be a central processing unit (“CPU”), a graphics processing unit (“GPU”), a Neural Processing Unit (“NPU”), a software implementation of a CPU, GPU, or NPU utilizing a Field-Programmable Gate Array (“FPGA”), or a combination thereof, a processor 1104, a storage medium 1106 (e.g., a database (not shown)), and/or any other suitable components (e.g., a memory, an input/output device, a display unit, a network interface device, a disk drive, etc.). The processor 1104 may be, for example, a microprocessor, a microcontroller, digital signal processor, or any other suitable processor. The processor 1104 may be communicatively coupled to the storage medium 1106 and/or a memory (not shown). The memory may be embodied as any type of suitable computer memory device, including fixed and/or removable memory devices (e.g., volatile memory such as a form of random access memory or a combination of random access memory and read-only memory, such as memory cards, e.g., SD cards, memory sticks, hard drives, and/or others). Program code, for example, the control algorithms disclosed herein, may be stored within the memory and/or on the storage medium 1106. The program code can be executed by the processor 1104 to perform various operations, as will be discussed in more detail below.

The control system 1100 may further include any number of suitable components for providing feedback to the controller 1102 and/or to which the control system 1100 provides instructions. Components that provide feedback or information to the control system 1100 shown in FIG. 11 include, but are not limited to, one or more imaging devices 1116 configured to capture video or images of the aquatic environment (for example, one or more of a camera or image sensor, a video camera, and/or any other suitable imaging device). In some examples, one or more imaging devices 1116 may be mounted on the housing of the pool cleaner 100, 200, 302, for example, at a front edge. In other examples, the imaging device 1116 may be mounted on other portions of the pool cleaner 100, 200, 302 and extend upwardly from the top. The imaging device 1116 is designed to be positioned in a location where debris in the aquatic environment may be sensed and recorded.

Additionally, the controller 1102 may be capable of sending instructions to the data capture system 1114 and/or the imaging device 1116, for example, to change an angle or viewing area of the imaging device 1116 or to perform other functions. In some examples, the controller 1102 may be in communication with the data capture system 1114 and/or the imaging device 1116 and may also send instructions to data capture system 1114 and/or the imaging device 1116 to continuously collect images of an aquatic environment. The controller 1102 may also send instructions to a drive system 1144 to control operation of the pool cleaner 100, 200, 302, to a directional control 1124 to control movement of the pool cleaner 100, 200, 302, and/or to any other components of the pool cleaner 100, 200, 302 to control any operation of the pool cleaner 100, 200, 302. The controller 1102 may also receive data from any of the components of the pool cleaner 100, 200, 302, for example, regarding function of those components (e.g., fault or other conditions).

In some examples, the communication device 1113 within the control system 1100 may be capable of sending instructions between the elements described herein. For example, the communication device 1113 may receive data from the controller 1102 and may also be capable of sending a signal to a remote user device (e.g., the user device 310 of FIG. 3). Additionally, the communication device 1113 may be capable of receiving information/data from any of the elements included within the system 1100 such as the imaging device 1116, drive system 1144, or other sensors 1120 and transmit the information to other elements of the system 1100 or another device described herein.

The control module or system 1100 may be further connected to a network, for example network 308 in FIG. 3, such that the control module or system 1100 can communicate with other devices, for example a computer, a mobile device (e.g., user device 310), control modules or systems of other suitable devices (e.g., docking station 312 or the one or more pool components 326). In this manner, instructions may be provided to the control module or control system 1100 to control various aspects of the pool cleaner 100, 200, 302. In an exemplary embodiment, a mobile device (e.g., by means of an application on the user device 310) may be utilized to turn the pool cleaner 100, 200, 302 on and off, control movement of the pool cleaner 100, 200, 302, control the operational schedule of the pool cleaner 100, 200, 302 and/or control any other components, functions, or features of the pool cleaner 100, 200, 302. In some cases, the network 308 of FIG. 3 may be capable of transmitting information to the communication device 1113 of the system 1100, thus allowing a remote connection to the elements connected to the system 1100.

Additionally, the control system 1100, through the controller 1102, may implement one or more algorithms that are intended to detect and identify debris, optimize cleaning paths, trajectories, or routes within an aquatic environment, for example the pool or spa 301, by identifying specific locations and types of debris within the aquatic environment and determining a navigation path to take based on size, type, and location of debris along each potential path and/or a smoothness of each potential path. During a cleaning operation, the control system 1100 may continuously evaluate different navigation paths and takes the best path at each evaluation until the entire aquatic environment is clean or until the pool cleaner 100, 200, 302 is turned off. In this manner, the time necessary to clean the aquatic environment is much less than conventional pool cleaners.

In some embodiments, a training module may perform iterative training of one or more detection models. In some embodiments, the one or more detection models can include an architecture with a certain number of layers and nodes, with biases and emphasis guidelines between the nodes. During training, the training module can determine the values of parameters (weights and biases) of the machine learning model, based on a set of training samples. In one instance, the training module receives a training set for training. The training samples in the training set may include images captured or obtained by the imaging devices 1116 (e.g., original image 702 of FIG. 7). For supervised learning, the training set may also include tags or labels for the images, e.g., in annotated image 700 of FIG. 7. The tags or labels can include whether or not the sample includes debris and/or non-debris.

In an example of iterative training, a training sample may be presented as an input to the one or more detection models, which may then produce an output for a particular attribute or parameter. The difference between the output of the one or more detection models and a known output may be used by the training module to evaluate and adjust (as needed) the values of the parameters in the one or more detection models. This may be iteratively repeated for a plurality of training samples to improve the performance of the one or more detection models.

The training module can also validate the trained one or more detection models based on additional validation samples. For example, the training module may apply the one or more detection models to a validation sample set to quantify the accuracy of the one or more detection models. The validation sample set can include images with associated known attributes, e.g., identified debris and/or non-debris. The output of the one or more detection models can be compared to the known attributes of the validation sample set. In one embodiment, developing the one or more detection models can include using validation data to compare to training data to determine if the one or more detection models were being overfit to the training data.

In other embodiments, other configurations are possible. For example, those of skill in the art will recognize, according to the principles and concepts disclosed herein, that various combinations, sub-combinations, and substitutions of the components discussed above can provide appropriate image processing, object detection and classification, and environment mapping, under a variety of operating conditions. All trademarks are the property of their respective owners.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An aquatic cleaning system to locate and remove debris from an aquatic environment, the aquatic cleaning system comprising:
a pool cleaner including a housing, a drive system designed to move the housing, and a debris basket associated with the housing;
a data capture system including an imaging device, the data capture system being operably coupled to the pool cleaner;
a detection system including a storage medium storing a trained model and a processor designed to receive data elements from the data capture system and input the data elements into the trained model to identify a detected object within the aquatic environment as being debris or non-debris; and
a control system in communication with the detection system and the drive system, the control system being designed to operate the drive system to move the pool cleaner toward the detected object identified by the detection system when the detected object is identified by the detection system as being debris.

2. The aquatic cleaning system of claim 1, wherein the detection system is further designed to perform at least one of avoiding identified non-debris, not collecting identified non-debris, ignoring the identified non-debris, sending a notification related to the identified non-debris, or collecting the identified non-debris.

3. The aquatic cleaning system of claim 1, wherein the non-debris includes at least one of a drain, a toy, jewelry, an owner possession, or a manufactured object.

4. The aquatic cleaning system of claim 1, wherein the data capture system includes an image processing module designed to receive images from the imaging device and to process the images to clarify at least one object in the images.

5. The aquatic cleaning system of claim 1, wherein the plurality of data elements includes a high-resolution image.

6. The aquatic cleaning system of claim 4, wherein the trained model includes an image library having images, wherein the detection system determines a type of detected object by comparing the received images to images in the image library.

7. The aquatic cleaning system of claim 6, wherein the images in the image library relate to at least one of a leaf, a stick, jewelry, a toy, a ring, a necklace, a bracelet, a fixed object, a drain, or an in-floor cleaning pop-up head.

8. The aquatic cleaning system of claim 1, wherein machine learning uses the trained model to classify the detected object and generate one or more confidence scores.

9. The aquatic cleaning system of claim 8, wherein a cleaning pathway is assigned based on the one or more confidence scores.

10. The aquatic cleaning system of claim 1, wherein the imaging device is a camera.

11. The aquatic cleaning system of claim 1, wherein the data capture system further comprises one or more ultrasonic sensors, and wherein the control system is further designed to use inputs from the one or more ultrasonic sensors to determine a distance to the detected object and to determine a size of the detected object based on the determined distance.

12. The aquatic cleaning system of claim 1, wherein the drive system includes an encoder designed to measure a distance traveled by the pool cleaner, and wherein the measured distance is used to map a shape and size of the aquatic environment.

13. A method for operating an aquatic cleaning system to locate and remove debris from an aquatic environment, the method comprising:
providing a pool cleaner having a data capture system including one or more one imaging devices and a detection system;
capturing an image of the aquatic environment via the one or more imaging devices;
providing the image to the detection system;
performing image processing on the image; and
identifying debris and non-debris in the image based on an output generated by the detection system.

14. The method of claim 13, further comprising: outputting a notification if the non-debris is detected.

15. The method of claim 13, further comprising: controlling the pool cleaner to collect the debris identified by the detection system.

16. The method of claim 13, further comprising: controlling the pool cleaner to ignore the non-debris identified by the detection system.

17. The method of claim 13, further comprising: controlling the pool cleaner to return to a docking station for recharging.

18. The method of claim 13, further comprising: providing a strobe, a flash, or other artificial light to illuminate the debris or the non-debris as the image is being captured.

19. The method of claim 13, wherein performing image processing on the image further comprises: determining if the image is too blurry, performing a sharpening operation if the image is too blurry, and removing one or more caustics if the image is not blurry.

20. An aquatic cleaning system to locate and remove debris from an aquatic environment, the aquatic cleaning system comprising:
a pool cleaner having a drive system designed to move the pool cleaner;
a data capture system in communication with the pool cleaner;
a detection system designed to receive a plurality of data elements from the data capture system and input the plurality of data elements into a trained model to identify a detected object within the aquatic environment as being debris or non-debris and output an image having confidence score associated with the image; and
a controller in communication with the detection system and the drive system, the controller engaging the drive system to move the pool cleaner toward the detected object identified by the detection system when the detected object is identified by the detection system as being debris.
